(19) United States
(12) Patent Application Publication
(10) Pub. No.: US 2026/0153459 A1
(43) Pub. Date: Jun. 4, 2026

(54) CALCULATION APPARATUS, CALCULATION METHOD, PROGRAM AND MACHINE-LEARNING MODEL GENERATING METHOD

(71) Applicant: RIGAKU CORPORATION, Tokyo (JP)

(72) Inventor: Toshihide SHIBASAKI, Tokyo (JP)

(73) Assignee: RIGAKU CORPORATION, Tokyo (JP)

(21) Appl. No.: 19/389,045

(22) Filed: Nov. 14, 2025

(30) Foreign Application Priority Data
Dec. 3, 2024 (JP) 2024-209964

(51) Int. Cl. G01N 23/2055; G01N 23/20058; G06N 3/045

(52) U.S. Cl. CPC G01N 23/2055; G01N 23/20058; G06N 3/045; G01N 2223/0566; G01N 2223/1016

(57) ABSTRACT

A calculation apparatus, a calculation method, a program, and a machine-learning model generating method for inferring a lattice volume from a profile of X-ray powder diffraction includes an information acquiring section for acquiring information on the profile of X-ray powder diffraction and an inference section for inferring the lattice volume from the acquired information on the profile of X-ray powder diffraction, the inference section including a machine-learning model for inputting information on the profile of X-ray powder diffraction and outputting the inferred lattice volume.

### CROSS-REFERENCE TO RELATED APPLICATION

This application claims priority from Japanese Patent Application No. 2024-209964 filed on Dec. 3, 2024, the entire contents of Japanese Patent Application No. 2024-209964 are incorporated herein by reference.

### FIELD

The present disclosure relates to a calculation apparatus, a calculation method, a program and a machine-learning model generating method for inferring a lattice volume from a profile of X-ray powder diffraction.

### DESCRIPTION OF RELATED ART

Patent Document 1 discloses a method of generating a peak position extraction model by machine learning in order to extract a peak position from an actual diffraction pattern obtained by irradiating powder crystals with radiation.

The method described in Patent Document 1 includes a learning data generation process of generating a diffraction pattern for learning from a known crystal structure, and a learning process of generating a peak position extracting model by machine learning using the diffraction pattern for learning as learning data. Non-Patent Document 1 describes a technique for learning and applying with a neural network model in which a XRD profile is input, and lattice parameters are output.

### Patent Document

Patent Document 1: JP2020-134382A

### Non-Patent Document

Non-patent Document 1: Sathya R. Chitturi et. al., Automated prediction of lattice parameters from X-ray powder diffraction patterns, J. Appl. Chryst. (2021). 54, 1799-1810.

### SUMMARY

In the method of Patent Document 1, only the peak position is determined, and the lattice volume and the lattice parameters are not calculated. In addition, since the inference of the angular parameter fails in the methods of Non-Patent Document 1, the lattice parameters of Monoclinic and Triclinic cannot be calculated.

The present inventors have discovered that when a lattice volume is determined using a machine-learning model, the lattice volume can be accurately determined only by a list of d-values obtained from an X-ray powder diffraction profile. Then, it was found that the calculation time of the lattice parameters can be shortened by using the lattice volume as an aid of the conventional method of determining the lattice parameters, and thus the present disclosure has been completed.

The present disclosure has been made in view of such circumstances, and an object thereof is to provide a calculation apparatus, a calculation method, a program and a machine-learning model generating method for inferring a lattice volume from a profile of X-ray powder diffraction.

(1) In order to achieve the above object, the calculation apparatus of the present disclosure has the following means. That is, a calculation apparatus according to an aspect of the present disclosure is a calculation apparatus for inferring a lattice volume from a profile of X-ray powder diffraction, the calculation apparatus comprising an information acquiring section for acquiring information on the profile of X-ray powder diffraction, and an inference section for inferring a lattice volume from the information on the profile of X-ray powder diffraction acquired by the information acquiring section, the inference section including a machine-learning model for inputting the information on the profile of X-ray powder diffraction and outputting the inferred lattice volume.

(2) Further, in the calculation apparatus according to an aspect of the present disclosure, the information on the profile of X-ray powder diffraction is a list of d-values from the profile of X-ray powder diffraction.

(3) Further, in the calculation apparatus according to an aspect of the present disclosure, the machine-learning model is a neural network model.

(4) Further, the calculation apparatus according to an aspect of the present disclosure further comprises a range determining section for determining a search range of the lattice volume based on the lattice volume inferred by the inference section, and a lattice parameter determining section for determining lattice parameters based on the search range of the lattice volume.

(5) Further, in the calculation apparatus according to an aspect of the present disclosure, training data for generating the machine-learning model includes information of crystal systems.

(6) Further, in the calculation apparatus according to an aspect of the present disclosure, the machine-learning model includes a plurality of models, and the plurality of models are generated by the training data including information of different crystal systems.

(7) Further, in the calculation apparatus according to an aspect of the present disclosure, the inference section uses at least one model among the plurality of models to infer the lattice volume in a case of a crystal system corresponding to the model.

(8) Further, in the calculation apparatus according to an aspect of the present disclosure, training data for generating the machine-learning model includes the list of d-values obtained by performing preprocess for integrating a plurality of peaks having a difference in peak positions equal to or less than a predetermined threshold value into a smaller number of peaks.

(9) Further, in the calculation apparatus according to an aspect of the present disclosure, the machine-learning model is generated by training data generated based on a training data generating condition.

(10) Further, in the calculation apparatus according to an aspect of the present disclosure, the training data does not include information of atomic positions.

(11) Further, in the calculation apparatus according to an aspect of the present disclosure, the training data generating condition includes a condition that the training data having lattice parameters from a lattice volume equal to or smaller than a predetermined lattice volume is generated.

(12) Further, a calculation method according to an aspect of the present disclosure is a method for inferring a lattice volume from a profile of X-ray powder diffraction, the method comprising acquiring information on the profile of X-ray powder diffraction, and inferring a lattice volume from the acquired information on the profile of X-ray powder diffraction by using a machine-learning model for inputting the information on the profile of the X-ray powder diffraction and outputting the inferred lattice volume.

(13) Further, a program according to an aspect of the present disclosure is a program for inferring a lattice volume from a profile of X-ray powder diffraction, the program causing a computer to execute acquiring information on the profile of X-ray powder diffraction, and inferring a lattice volume from the acquired information on the profile of X-ray powder diffraction by using a machine-learning model for inputting the information on the profile of the X-ray powder diffraction and outputting the inferred lattice volume.

(14) Further, a machine-learning model generating method according to an aspect of the present disclosure is a machine-learning model generating method for inputting information on a profile of X-ray powder diffraction and then outputting a lattice volume inferred from the information on the profile of X-ray powder diffraction, the method comprising setting a training data condition, setting a structure of the machine-learning model, inputting the information on the profile of X-ray powder diffraction based on the training data condition, outputting the lattice volume corresponding to the information on the profile of X-ray powder diffraction, and optimizing the machine-learning model based on the plurality of training data.

### BRIEF DESCRIPTION OF THE DRAWINGS

FIG. 1 is a block diagram showing an example of a configuration of the calculation apparatus according to a first embodiment.

FIG. 2 is a flowchart showing an example of an operation of the calculation apparatus according to the first embodiment.

FIG. 3 is a flowchart showing an example of a machine-learning model generating method.

FIG. 4A and FIG. 4B are schematic block diagrams showing configuration examples of a machine-learning model included in the inference section, respectively.

FIG. 5 is a block diagram showing an example of a configuration of the calculation apparatus according to a second embodiment.

FIG. 6 is a flowchart showing an example of the operation of the calculation apparatus according to the second embodiment.

FIG. 7 is a schematic diagram showing an example of the configuration of the system.

FIG. 8 is a block diagram showing an example of configurations of the control apparatus and the calculation apparatus.

FIG. 9 is a block diagram showing a modified example of configurations of the control apparatus and the calculation apparatus.

FIG. 10 is a table showing the median absolute error for each crystal system of the test data of example 1.

FIG. 11 is a table showing the lattice volume of each crystal phase of example 2, its inferred value, the time required to determine the lattice parameters in the method of the present disclosure and the time required to determine the lattice parameters in the conventional method.

### DETAILED DESCRIPTION

Next, embodiments of the present disclosure are described with reference to the drawings. To facilitate understanding of the description, the same reference numerals are assigned to the same components in the respective drawings, and duplicate descriptions are omitted. Indexing is a method for calculating the lattice parameters (a, b, c, α, β, γ) of the crystal phase from the X-ray diffraction profile and is used for determining the lattice parameters of the crystal phase not registered in the database. The lattice parameters and the peak position of the X-ray diffraction profile are closely related to each other, and DICVOL, N-TREOR, ITO or the like is used as a program for calculating the lattice parameters from the X-ray diffraction profile. In these programs, there has been a problem that the processing time is prolonged depending on the symmetry of the crystal system. Therefore, a program for determining lattice parameters using AI has been studied.

### Embodiment

### (First Embodiment)

### [Calculation Apparatus]

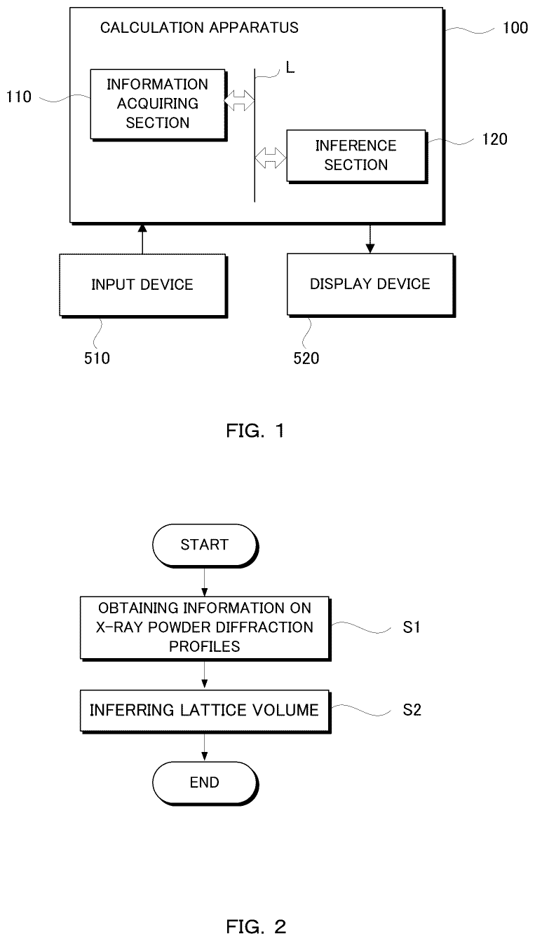

In the first embodiment, a case where the lattice volume is inferred is described. FIG. 1 is a block diagram showing an example of a configuration of a calculation apparatus 100 according to the first embodiment. The calculation apparatus 100 may be connected to the X-ray diffraction apparatus 200 via a control apparatus 300 for controlling the X-ray diffraction apparatus 200 described below or directly.

The calculation apparatus 100 infers the lattice volume from the profile of X-ray powder diffraction. The calculation apparatus 100 is configured by a computer formed by connecting a CPU (Central Processing Unit), a ROM (Read Only Memory), a RAM (Random Access Memory), and a memory to a bus. The calculation apparatus 100 may be a PC terminal or a server on a cloud. Not only the whole apparatus but also part of the apparatus or some functions of the apparatus may be provided on the cloud. The input device 510 and the display device 520 are connected to CPU of the calculation apparatus 100 via an appropriate interface. The input device 510 is, for example, a keyboard or a mouse and performs input to the calculation apparatus 100. The display device 520 is, for example, a display, and displays an inferred lattice volume, lattice parameters, a crystal system and the like.

The calculation apparatus 100 comprises an information acquiring section 110 and an inference section 120. Each section can transmit and receive information via the control bus L.

The information acquiring section 110 acquires information on the profile of X-ray powder diffraction. The information acquiring section 110 may acquire information on the profile of X-ray powder diffraction directly from the X-ray diffraction apparatus 200 or via the control apparatus 300. Further, the information on the profile of X-ray powder diffraction stored in the storage device or the like after the measurement by the X-ray diffraction device 200 may be acquired.

The information on the profile of X-ray powder diffraction includes the profile itself, a list of d-values, and further a combination of a list of d-values and their peak intensities, and the like. In the list of d-values, the information on the peak intensity is not included. As the list of d-values, a list made from the profile of X-ray powder diffraction with existing peak search methods can be used. The information on the profile of X-ray powder diffraction may be a list of d-values. This is because a list of d-values alone enables inferring the lattice volume.

The inference section 120 includes a machine-learning model that receives the information on the profile of X-ray powder diffraction as an input and outputs the lattice volume and infers the lattice volume from the information on the profile of X-ray powder diffraction acquired by the information acquiring section 110. The inferred lattice volume may be expressed in various types and may be the volume itself or the cubic root of the volume. Further, the range of these may be inferred. Further, it is assumed that the machine-learning model is already generated and held at the stage when the inference section 120 infers the lattice volume. A method of generating the machine-learning model and details of the training data for generating the machine-learning model are described later.

As is described later, when the machine-learning model includes a plurality of models, the inference section 120 may infer the lattice volume in the crystal system corresponding to the model by using at least one model among the plurality of models. Inferring the lattice volume in the crystal system corresponding to the model refers to inferring the lattice volume when the input information on the X-ray powder diffraction profile is assumed to be the crystal system corresponding to the model. One model may correspond to multiple crystal systems. Inferring the lattice volume in the crystal system corresponding to the model also includes inferring the lattice volume using a model that does not limit the information of the crystal system. As the model used by the inference section 120, a model corresponding to the given information of the crystal system can be selected, and a model designated by a user can be allowed. If there is no information on crystal system or user designation, the inference section 120 may infer the lattice volumes for all models sequentially or in parallel.

FIG. 2 is a flowchart showing an example of an operation of the calculation apparatus 100 according to the first embodiment. FIG. 2 shows a series of procedures for only inferring the lattice volume. First, the calculation apparatus 100 acquires information on the profile of X-ray powder diffraction by the information acquiring section 110 (step S1). Next, the inference section 120 infers the lattice volume from the information on the profile of X-ray powder diffraction acquired by the information acquiring section 110 (step S2). The inference section 120 may output the inferred lattice volume as necessary. In this way, the lattice volume can be inferred from the information on the profile of X-ray powder diffraction. The inferred lattice volume can also be used to determine the lattice parameters.

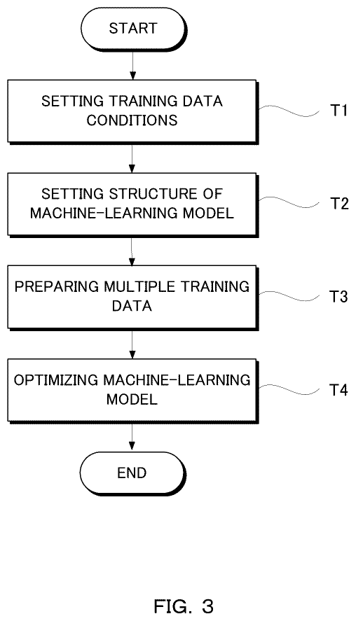

Next, a machine-learning model generating method is described. FIG. 3 is a flowchart showing an example of a machine-learning model generating method. First, a training data condition is set (step T1). The training data condition refers to a condition for training data used for machine learning, and corresponds to a scan range, a range of lattice parameters, a wavelength of an X-ray or the like. When the training data is generated, the training data condition is a generation condition of the training data.

Next, the structure of the machine-learning model is set (step T2). The setting for the structure of the machine-learning model refers to setting the type of machine-learning model to be used and the specific structure thereof. For example, when a neural network model is used as the machine-learning model, the number of layers, the number of nodes, the type of layers and the like are set. Further, the training data condition or the structure of the machine-learning model may be arbitrarily set by a user selecting, specifying, inputting or the like. The setting of the training data condition and the setting of the structure of the machine-learning model may be performed either first or simultaneously.

Next, a plurality of pieces of training data are prepared (step T3). As the training data, a plurality of pieces of data having information on the profile of X-ray powder diffraction as input and the lattice volume corresponding to the information on the profile of X-ray powder diffraction as output are prepared based on the training data condition.

Then, the machine-learning model is optimized based on the plurality of training data (step T4). As the optimization method, a general method can be used on the machine-learning model based on the type and a specific structure of machine-learning model to be applied. In parallel with the optimization, new training data may be generated. Thereafter, the optimized machine-learning model or its parameters are stored, and parameters and the like are output as necessary. When a plurality of models is generated, this series of processing is performed again from the setting of the training data condition.

The machine-learning model may be a neural network model. Thus, the accuracy of the inferred lattice volume can be increased.

The training data used to generate the machine-learning model may include information on a crystal system. Thus, it is possible to generate a machine-learning model that is different for each crystal system, or to generate a machine-learning model that infers and outputs the crystal system. The crystal system information is information indicating the crystal system of the sample used to measure or generate the training data, and the form thereof may be any type.

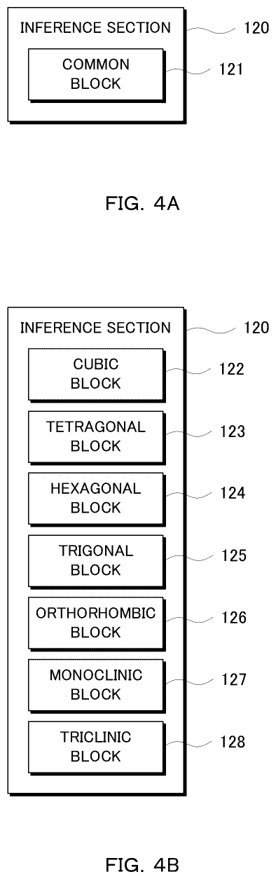

FIG. 4A and FIG. 4B are schematic block diagrams showing configuration examples of a machine-learning model implemented in the inference section 120, respectively. The machine-learning model may be composed of a single model as shown in FIG. 4A and may be composed of a plurality of models as shown in FIG. 4B. When the machine-learning model is composed of a plurality of models, the plurality of models may be generated by training data including information of different crystal systems. Further, each model may be generated by training data including only specific crystal system information. Thus, a machine-learning model optimized for each crystal system can be constructed, and the accuracy of inference of the lattice volume is improved.

Note that the machine-learning model 121 of the common block in FIG. 4A is a machine-learning model generated by the training data that does not include the information of the crystal system, that is, the training data that is not limited to data for the crystal system. The machine-learning models 122 to 128 of the respective blocks in FIG. 4B are machine-learning models generated by the training data corresponding to the crystal system, that is, the training data including the information of the crystal system. In FIG. 4B, the inference section 120 including a machine-learning model that is different for each of the seven crystal systems is illustrated, but a plurality of crystal systems may be integrated as a small number of machine-learning models as necessary. Further, the inference section 120 may include at least one machine-learning model of a common block and a machine-learning model of a crystal system block. Further, the inference section 120 may adopt a machine-learning model for each point group or space group depending on a method of determining lattice parameters.

The training data of the machine-learning model may include a list of pre-processed d values obtained by integrating a plurality of peaks whose peak position difference is a predetermined threshold or smaller into a smaller number of peaks. By performing such preprocessing, it is possible to construct the training data having the same accuracy as in the case of performing the peak search on the measured data. As a result, the accuracy of inference of the lattice volume with respect to the list of d-values based on the measured data is improved. As a specific preprocessing method, a method of integrating a plurality of peaks having a difference in peak position equal to or less than a threshold value into peaks at an average position or a centroid, or a method of determining two or less peak positions from three or more peaks may be used. The preprocessing may be performed automatically based on a set rule.

The training data of the machine-learning model can be generated not only by using the data extracted from the database but also by mechanically generating a set of lattice parameters without using the database. That is, the machine-learning model may be generated by the training data generated based on the training data generating condition. By this method, a large number of training data items can be secured, and the number of training data items per space group or set of lattice parameters is unlikely to be unbalanced. As a result, it is possible to generate a machine-learning model that enables highly accurate inference even for a sample having a rare crystal system.

The training data may not include information of the atomic position. Thus, the peak position can be efficiently calculated, and a list of d-values can be easily generated. In particular, it becomes easy to mechanically generate a set of lattice parameters, and it is possible to generate theoretically possible training data in a short time.

The training data generating condition may include a condition that training data having lattice parameters that is equal to or smaller than a predetermined lattice volume is generated. Due to the constraint of the generation condition, it is possible to efficiently generate the training data necessary for generating the machine-learning model. As a result, highly accurate inference can be performed in a short time. The predetermined lattice volume may be specified by a user.

### (Second Embodiment)

### [Calculation Apparatus]

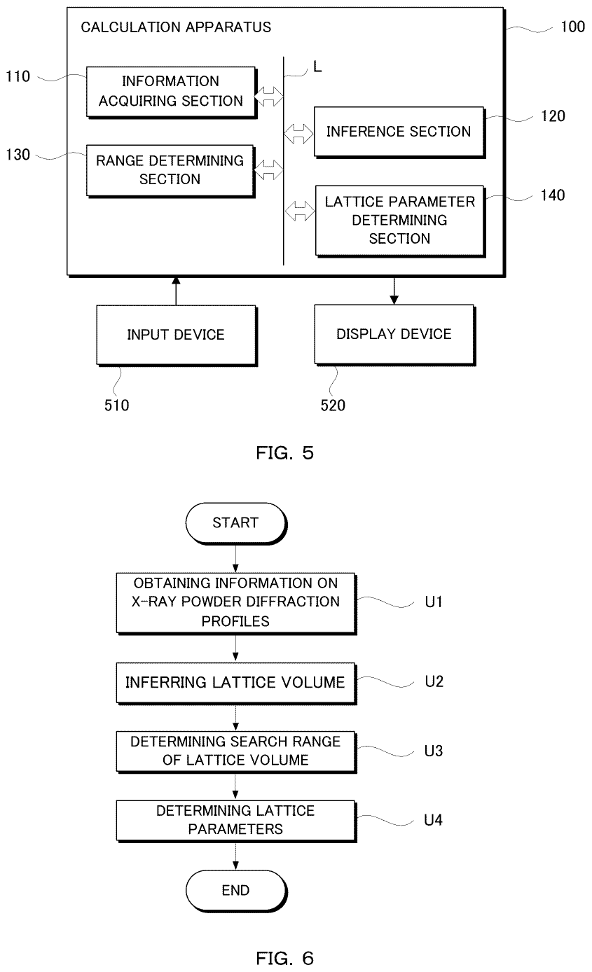

In the second embodiment, a method of determining the lattice parameters based on the inferred lattice volume is described. Since the method of inferring the lattice volume is the same as that of the first embodiment, a method of determining the lattice parameters that is performed after that is described. FIG. 5 is a block diagram showing an example of a configuration of the calculation apparatus 100 according to the second embodiment. As shown in FIG. 5, the calculation apparatus 100 may comprise a range determining section 130 and a lattice parameter determining section 140 in addition to the information acquiring section 110 and the inference section 120. Note that the calculation apparatus 100 having this configuration may be referred to as a calculation apparatus that calculates the lattice parameters from the profile of X-ray powder diffraction.

The range determining section 130 determines a search range of the lattice volume based on the lattice volume inferred by the inference section 120. The search range may be a range obtained by adding or subtracting a predetermined constant to or from the inferred lattice volume or may be set at any time based on inferred lattice volume or crystal system information. Further, the search range may be arbitrarily set by selection or instruction of the user. When the inference section 120 outputs a predetermined range, the calculation apparatus 100 of the present embodiment may not comprise the range determining section 130 but may comprise the lattice parameter determining section 140.

The lattice parameter determining section 140 determines the lattice parameters based on the search range of the lattice volume. The lattice parameter determining section 140 may determine the lattice parameters based on the information of the crystal system in addition to the search range of the lattice volume. When the machine-learning model of the inference section 120 includes a plurality of models and there is a plurality of inferred lattice volumes, the lattice parameter determining section 140 may search for lattice parameters for each of the inferred lattice volume. This processing may be implemented sequentially or in parallel. If a plurality of candidates of the lattice parameters is obtained, the degree of coincidence with the X-ray powder diffraction profile may be evaluated, and the lattice parameters may be determined programmatically. In addition, a plurality of candidates may be displayed so that the user can select one of the candidates. An evaluation of the degree of coincidence with the profile of X-ray powder diffraction may be displayed as information for the user to select. The lattice parameter determining section 140 may have a function of determining lattice parameters but may be configured to provide required data to an external device or software (such as a DICVOL, NTREOR, ITO) to determine lattice parameters.

FIG. 6 is a flowchart showing an example of the operation of the calculation apparatus 100 according to the second embodiment. FIG. 6 shows the operation in the case where the lattice parameters are determined after the lattice volume is inferred. First, the calculation apparatus 100 acquires information on the X-ray powder diffractometry profile by the information acquiring section 110 (step U1). Next, the calculation apparatus 100 infers the lattice volume from the information on the profile of the acquired X-ray powder diffraction by the inference section 120 (step U2). If necessary, the inference section 120 may output the inferred lattice volume. The operation so far is the same as that of the first embodiment.

Next, the calculation apparatus 100 determines the search range of the lattice volume by the range determining section 130 (step U3). The range determining section 130 may output the determined search range as necessary. Then, the calculation apparatus 100 determines the lattice parameters by the lattice parameter determining section 140 (step U4). The lattice parameter determining section 140 may output the determined lattice parameters as necessary. In this way, the lattice volume can be inferred from the information on the profile of X-ray powder diffraction, and the lattice parameters can be determined.

### [Whole System]

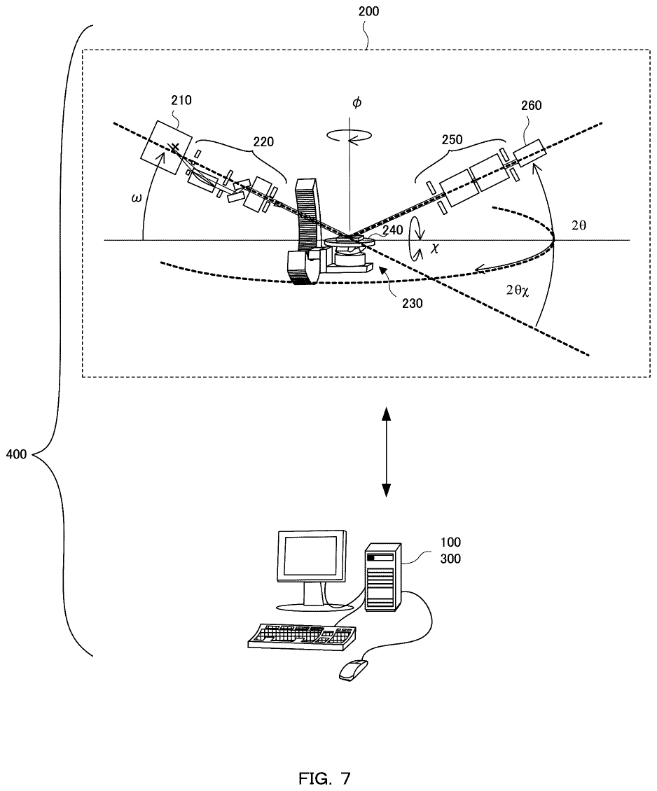

The calculation apparatus 100 or the computing method of the present disclosure is operable independently of the X-ray diffraction apparatus 200 and the control apparatus 300 and can obtain a profile of the powder X-ray diffraction to infer the lattice volume and determine the lattice parameters. Therefore, the calculation apparatus 100 does not need to be used at the same time as the X-ray diffraction apparatus 200 or the control apparatus 300. On the other hand, the system may be integrated with the X-ray diffraction apparatus 200 and the control apparatus 300. FIG. 7 is a schematic diagram showing an example of the configuration of the system 400 including a calculation apparatus 100 and an X-ray diffraction apparatus 200. The system 400 comprises the calculation apparatus 100, the X-ray diffraction apparatus 200 and the control apparatus 300.

In FIG. 7, the calculation apparatus 100 and the control apparatus 300 are described as the same PC. However, the calculation apparatus 100 may be configured as an apparatus different from the control apparatus 300. Hereinafter, a case where the calculation apparatus 100 and the control apparatus 300 are configured as different apparatuses is described.

### [X-Ray Diffraction Apparatus]

The X-ray diffraction apparatus 200 constitutes an optical system that makes X-rays incident on a sample and detects reflected X-rays generated from the sample. The X-ray diffraction apparatus 200 comprises at least an X-ray generating section 210 that generates X-rays from an X-ray focal point or X-ray source, a sample stage 240 on which a sample is located and controls rotation of the sample, and a detector 260 that detects X-rays. The X-ray diffraction apparatus 200 may be configured to comprise an incident-side optical unit 220, a goniometer 230 or an emitting-side optical unit 250. Since the X-ray generating section 210, the incident-side optical unit 220, the goniometer 230, the sample stage 240, the emission-side optical unit 250 and the detector 260 constituting the X-ray diffraction apparatus 200 need only be general, a detailed description thereof is omitted. Incidentally, the configuration shown in FIG. 7 is one example, and thus a variety of other configurations may be adopted.

### [Control Apparatus]

The control apparatus 300 is connected to the X-ray diffraction apparatus 200 to control the X-ray diffraction apparatus 200 and process, store and display the acquired data.

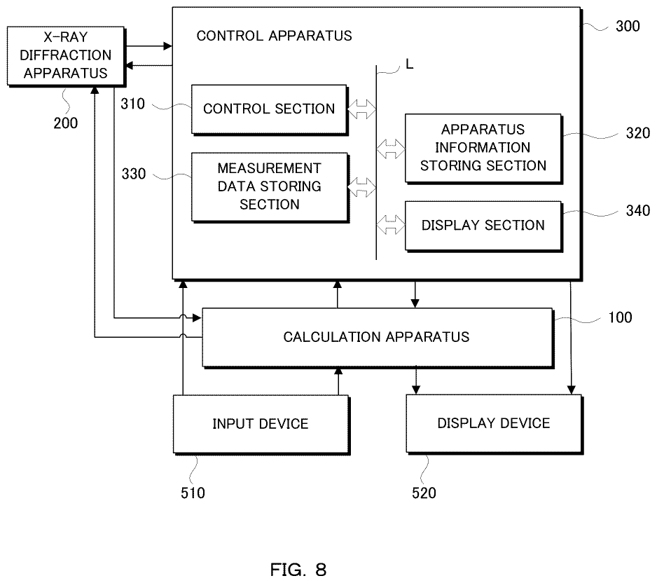

FIG. 8 is a block diagram showing an example of configurations of the control device 300 and the calculation apparatus 100. The control apparatus 300 is configured from a computer formed by connecting CPU, ROM, RAM and a memory to a bus. The control apparatus 300 may be a PC terminal or a server on the cloud. Not only the whole apparatus but also part of the apparatus or some functions of the apparatus may be provided on the cloud. The control apparatus 300 is connected to the X-ray diffraction apparatus 200 to receive information.

The control apparatus 300 comprises a control section 310, an apparatus information storing section 320, a measurement data storing section 330, and a display section 340. Each section can transmit and receive information via the control bus L. When the calculation apparatus 100 and the control apparatus 300 are structurally separate, the input device 510 and the display device 520 are connected to CPU of the control apparatus 300 via an appropriate interface. In this case, the input device 510 and the display device 520 may be different from those connected to the calculation apparatus 100.

The control section 310 controls the operations of the X-ray diffraction apparatus 200. The apparatus information storing section 320 stores apparatus information acquired from the X-ray diffraction apparatus 200. The apparatus information may include information on the X-ray diffraction apparatus 200, such as apparatus name, source type, wavelength, background, etc.

The measurement data storing section 330 stores measurement data including a two-dimensional diffraction image acquired from the X-ray diffraction apparatus 200. In addition to the measurement data, necessary information among information on the X-ray diffraction apparatus 200 such as the source type, the wavelength, and the background, the shape and the arrangement the type of the constituent elements, the composition and the absorption coefficient of the sample may be stored. The display section 340 causes the display device 520 to display measurement data and the like. Thus, the measurement data, etc. can be checked by a user. In addition, the user can instruct and designate the control apparatus 300, the calculation apparatus 100 and the like based on the measurement data and the like.

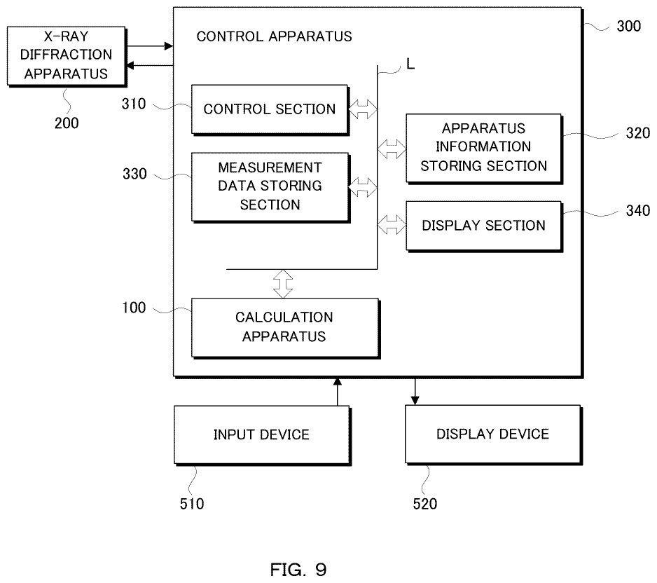

FIG. 9 is a block diagram showing a modified example of configurations of the control device 300 and the calculation apparatus 100. As shown in FIG. 9, the calculation apparatus 100 may be configured as a part of functions included in the control device 300. In addition, the calculation apparatus 100 and the control apparatus 300 may be configured as an integrated apparatus.

### [Measurement Method]

A sample is placed in the X-ray diffraction apparatus 200, and X-rays are made to enter the sample under the control of the control apparatus 300, and diffracted X-rays generated from the sample are detected. If necessary, the sample stage or the goniometer is driven under a predetermined condition. Thus, a profile of X-ray powder diffraction is acquired. The X-ray diffraction apparatus 200 transmits the apparatus information and the like and the acquired profile of X-ray powder diffraction to the control apparatus 300 as measurement data.

By using the system 400 described above, the profile of X-ray powder diffraction can be measured, and the lattice volume can be inferred from the information on the profile. The inferred lattice volume can also be used to determine the lattice parameters.

### EXAMPLE

### Example 1

In example 1, a calculation apparatus including a plurality of machine-learning models was configured using randomly generated training data. Specifically, as a machine-learning model, a neural network model consisting of 10 fully-connected layers was applied. And, the cell was randomly generated for each crystal system, and the neural network model which was different for each crystal system was generated using the list of d-values and the set of lattice volumes as training data. A list of d-values was used where adjacent peaks were preprocessed to be integrated. 2 million sets of training data were generated for each crystal system. The neural network model was generated for each of six types of crystalline systems in which Trigonal was included in Hexagonal.

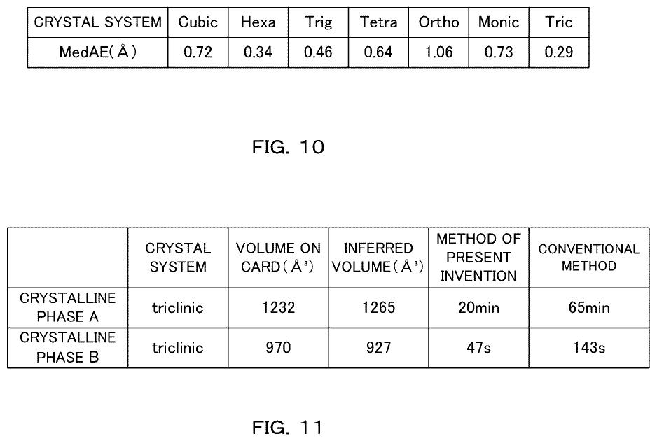

Next, apart from the training data used to generate the neural network model, a list of d-values (test data) of randomly generated cells for each crystal system was input to the calculation apparatus, and the error between the cubic root of the inferred lattice volume and the cubic root of the actual lattice volume was confirmed. FIG. 10 is a table showing the median absolute error (MedAE: Median Absolute Error) for each crystal system of the test data of example 1. Trigonal and Hexagonal were confirmed using different test data. As a result of inputting 300 sets of test data for each crystal system and examining the median absolute error, it was confirmed that the error was about 1 Å even in the crystal system with large error, although a slight difference was observed for each crystal system. Thus, it was confirmed that the method of the present disclosure enabled accurately inferring the lattice volume.

### Example 2

In example 2, the lattice volume of the actual material was inferred using the same calculation apparatus as in example 1, and the lattice parameters were determined.

First, two cards were randomly extracted from PDF-5+Organic sub-file in which the crystal system was Triclinic, and each of the cards was used as the crystal phase A and the crystal phase B of the organic material. Then, the list of the d-values on the cards was entered into the calculation apparatus, and Triclinic block was instructed to infer the cubic root of the lattice volume. Later, the lattice parameters were searched and determined by setting the crystal system to Triclinic using DICVOL with (cubic root of the lattice volume±0.5)³ Å³ as the search range for the cubic root of the inferred lattice volume. Further, in the conventional method, the lattice parameters were determined by setting the crystal system to Triclinic using DICVOL with 0 to 2500 Å³ as the search range. FIG. 11 is a table showing the lattice volume of each crystal phase of example 2, its inferred value, the time required to determine the lattice parameters in the method of the present disclosure and the time required to determine the lattice parameters in the conventional method.

As shown in FIG. 11, when the lattice volume is inferred by applying the method of the present disclosure, and the lattice parameters are determined using its value as a constraint condition, it was confirmed that the result of the same degree of accuracy can be obtained in a short time as compared with the time required for determining the lattice parameters by the conventional method. In the method of the present disclosure, since the inference of the lattice volume can be performed in a sufficiently short time, the lattice parameters can be determined in a shorter time than that in the conventional method even in a case where the crystal system information of the sample is unknown.

From the above results, it was confirmed that the calculation apparatus, the method, and the program of the present disclosure can infer the lattice volume from the profile of X-ray powder diffraction. It was also confirmed that the lattice parameters can be determined in a short time by using the inferred lattice volume.

The functionality of the elements disclosed in this specification may be implemented using general purpose processors, special purpose processors, integrated circuits, ASICs (Application Specific Integrated Circuits), FPGAs (Field Programmable Gate Arrays), conventional circuits, and/or circuitry or processing circuitry including combinations thereof that are programmed using one or more programs stored in one or more memories or otherwise configured to perform the disclosed functions. The processor can be regarded as a circuitry or a processing circuitry because it comprises transistors and other circuits. The processor may be a programmed processor that executes programs stored in memory. In this disclosure, a circuit, unit, or means is hardware that performs the recited functions or is hardware programmed to perform the recited functions. The hardware may be any hardware disclosed in this specification that is programmed or configured to perform the recited functions.

### DESCRIPTION OF SYMBOLS

100 calculation apparatus
110 information acquiring section
120 inference section
121 to 128 machine-learning model
130 range determining section
140 lattice parameter determining section
200 X-ray diffraction apparatus
210 X-ray generating section
220 incident side optical unit
230 goniometer
240 sample stage
250 emitting side optical unit
260 detector
300 control apparatus
310 control section
320 apparatus information storing section
330 measurement data storing section
340 display section
400 system
510 input device
520 display device

What is claimed is:

1. A calculation apparatus, comprising:
processing circuitry configured to
acquire information on a profile of X-ray powder diffraction, and
infer a lattice volume from the acquired information on the profile of X-ray powder diffraction, based on a machine-learning model that receives as input the information on the profile of X-ray powder diffraction and outputs the inferred lattice volume.

2. The calculation apparatus according to claim 1,
wherein the information on the profile of X-ray powder diffraction is a list of d-values from the profile of X-ray powder diffraction.

3. The calculation apparatus according to claim 1,
wherein the machine-learning model is a neural network model.

4. The calculation apparatus according to claim 1, wherein the processing circuitry is further configured to
determine a search range of the lattice volume based on the inferred lattice volume, and
determine lattice parameters based on the search range of the lattice volume.

5. The calculation apparatus according to claim 1,
wherein training data for generating the machine-learning model includes information of crystal systems.

6. The calculation apparatus according to claim 5,
wherein the machine-learning model includes a plurality of models, and
the plurality of models is generated by the training data including information of different crystal systems.

7. The calculation apparatus according to claim 6,
wherein the processing circuitry is further configured to
use at least one model among the plurality of models to infer the lattice volume in a case of a crystal system corresponding to the model.

8. The calculation apparatus according to claim 2, wherein the processing circuitry is further configured to
perform preprocessing for integrating a plurality of peaks having a difference in peak positions equal to or less than a predetermined threshold value into a smaller number of peaks, and
obtain the list of d-values based on the preprocessing, wherein training data for generating the machine-learning model includes the obtained list of d-values.

9. The calculation apparatus according to claim 1, wherein the processing circuitry is further configured to
generate the machine-learning model with training data generated based on a training data generating condition.

10. The calculation apparatus according to claim 9,
wherein the training data does not include information of atomic positions.

11. The calculation apparatus according to claim 9,
wherein the training data generating condition includes a condition that the training data having lattice parameters from a lattice volume equal to or smaller than a predetermined lattice volume is generated.

12. A calculation method, the method comprising:
acquiring information on a profile of X-ray powder diffraction; and
inferring a lattice volume from the acquired information on the profile of X-ray powder diffraction by using a machine-learning model for inputting the information on the profile of the X-ray powder diffraction and outputting the inferred lattice volume.

13. A non-transitory computer-readable recording medium having recorded thereon a program for inferring a lattice volume from a profile of X-ray powder diffraction, the program causing a computer to perform a method, the method comprising:
acquiring information on the profile of X-ray powder diffraction; and
inferring a lattice volume from the acquired information on the profile of X-ray powder diffraction by using a machine-learning model for inputting the information on the profile of the X-ray powder diffraction and outputting the inferred lattice volume.
